(19) United States
(12) Patent Application Publication
(10) Pub. No.: US 2018/0267490 A1
(43) Pub. Date: Sep. 20, 2018

(54) COGNITIVE COMPUTING CONTROL OF A POTENTIALLY HAZARDOUS ITEM

(71) Applicant: International Business Machines Corporation, Armonk, NY (US)

(72) Inventors: Michael S. Gordon, Yorktown Heights, NY (US); Jinho Hwang, Ossining, NY (US); Roxana Monge Nunez, San Jose (CR); Maja Vukovic, New York, NY (US)

(21) Appl. No.: 15/459,722

(22) Filed: Mar. 15, 2017

(51) Int. Cl. G05B 19/048

(52) U.S. Cl. CPC G05B 19/048; G05B 2219/25369

(57) ABSTRACT

A cognitive control of a potentially hazardous item is disclosed. A user profile can be generated for the potentially hazardous item, the user profile including a risk value and a risk threshold. A risk value can be calculated for the potentially hazardous item based on the user profile and context associated with the potentially hazardous item. The risk value can be continuously determined. The risk value can be compared to the risk threshold, and the operational state of the potentially hazardous item changed a first state to a second state, based at on a determination that the risk value exceeds the risk threshold.

### BACKGROUND

The present invention relates in general to control systems and, more particularly to cognitive computing control of potentially hazardous items.

A potentially hazardous item, such as a handgun, rifle, shotgun, aerosol defense spray, bow and arrow, electroshock device (e.g., a taser), nail gun, power tool, kitchen appliance, and the like can be used for a variety of reasons. Potentially hazardous items often also perform useful functions. However, they are potential hazards if used incorrectly or if involved in some type of accident.

### SUMMARY

Embodiments of the present invention include computer-implemented methods, systems, and/or computer program products. An example computer-implemented method includes generating, by a processing device, a profile for the potentially hazardous item. The processing device calculates a risk value associated with the potentially hazardous item. The risk value is calculated based at least in part on the profile, as well as a context of the potentially hazardous item. Based at least in part on the risk value the processing device changes the operational state of the potentially hazardous item from the first state to the second state.

Additional features and aspects of the invention are described in detail herein and are considered a part of the invention.

### BRIEF DESCRIPTION OF THE DRAWINGS

The subject matter which is regarded as the invention is particularly pointed out and distinctly claimed in the claims at the conclusion of the specification. The foregoing and other features, and advantages thereof, are apparent from the following detailed description taken in conjunction with the accompanying drawings, in which:

FIG. 1 depicts an example of a system according to embodiments of the present invention;

FIG. 2 depicts an example of a system and network according to embodiments of the present invention;

FIG. 3 depicts an example of a computer-implemented method according to embodiments of the present invention;

FIG. 4 depicts another example a system according to embodiments of the present invention;

FIG. 5 depicts an example of a cloud computing environment according to embodiments of the present invention; and

FIG. 6 depicts an example of abstraction model layers of a system according to embodiments of the present invention.

### DETAILED DESCRIPTION

Although potentially hazardous items can be used for a variety of beneficial and productive reasons (e.g., household tasks, hunting, self-defense, etc.), sometimes a potentially hazardous item can be involved in an accident. A few non-limiting examples potentially hazardous item include, a gun, knife, aerosol defense spray, bow and arrow, electroshock device (e.g., a taser), nail gun, power tool, and a kitchen appliance. For example, if a child accesses and uses a potentially hazardous item, an injury can occur to the child, another person or property, which can have lasting and devastating consequences.

Some embodiments of the present invention described herein are techniques for automatically and selectively determining and changing the operation of a potentially hazardous item, e.g., based at least in part on the context and state of the user. Some embodiments include execution by a cognitive computing device (e.g., a computing device that employs cognitive learning techniques) that controls functionality of a potentially hazardous item. A result of the computing device executing the novel technique is that the computing device “learns” the user's context and cognitive state and adapts the functionality of the potentially hazardous item accordingly. For example, patterns of misuse or potential for misuse can be determined to disable the potentially hazardous item, thereby possibly preventing accidents.

To do this, some embodiments assess risk in the use of a potentially hazardous item based on information associated with different cohorts of people in different contexts, and ameliorate the behavior of the potentially hazardous item to prevent misuse and tragic outcomes. In some embodiments, a cognitive control system associated with the potentially hazardous item can learn about the user to generate (and/or modify) a user profile with information that can be used to facilitate a risk assessment. For example, the potentially hazardous item may be disabled and an alert provided if the item is detected as currently associated with an unauthorized person. By way of further example only, a child may be detected as playing with the potentially hazardous item, or any other abnormal patterns are detected. Further to the above example, it can be determined that a child is playing with the potentially hazardous item based on detection of small hands, clumsy movements, and/or an inappropriate location of the item (such as the child's room, a playground, etc.), and the like.

Some embodiments of the present invention change the operational state of a potentially hazardous item between a first state and a second state based on a detected context. In some embodiments, the first state is an activated state in which the potentially hazardous item is operational and the second state is a deactivated state in which the potentially hazardous item is not operational.

In some embodiments of the present invention, a user profile is generated for the potentially hazardous item. By way of example only, the profile may be a user profile that includes a risk threshold for the user. In some embodiments, a risk value associated with the potentially hazardous item is calculated based at least in part on the user profile associated with the potentially hazardous item. In some embodiments, it can be continuously determined whether the calculated risk level exceeds the risk threshold for the user by comparing the risk value to a risk threshold of the user's profile. The state of the potentially hazardous item can be changed from the first (e.g., activated) state to the second (e.g., deactivated) state based at least in part on a determination that the risk value exceeds the risk threshold. That is, if the risk is too great in comparison to the risk threshold, the potentially hazardous item is deactivated. This can reduce the risk of accidents (e.g., unintentional discharge) involving the potentially hazardous item. These and other advantages will be apparent from the description that follows.

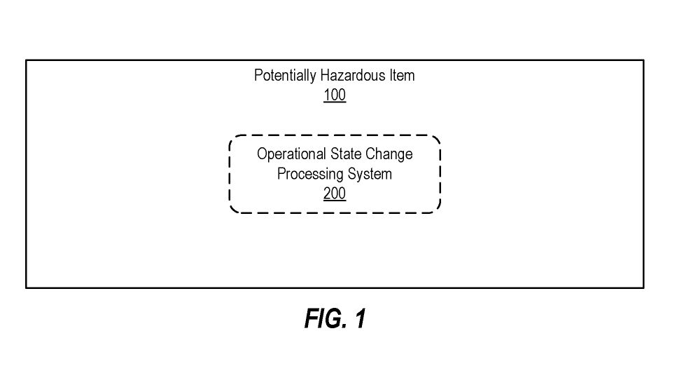

FIG. 1 illustrates an exemplary system according to embodiments of the present invention. A potentially hazardous item can be any hazardous or potentially hazardous item, such as a weapon (e.g., handgun, rifle, shotgun, aerosol spray (e.g., pepper spray), bow and arrow, electroshock item (e.g., a taser)), kitchen appliance (e.g., a blender), etc.

Referring now specifically to FIG. 1, the potentially hazardous item 100 includes an operational state change processing system (also referred to as a “processing system”) 200. The processing system 200 can evaluate risks associated with the potentially hazardous item 100 and determine whether to change a state of the potentially hazardous item 100 e.g., to deactivate a currently active state of the potentially hazardous item 100. Examples of processing system 200 are provided below.

By way of overview, in some embodiments, the processing system 200 calculates a risk value (not depicted) associated with the potentially hazardous item 100, based at least in part on a profile containing information about a user of the potentially hazardous item 100 and/or context informational associated with the potentially hazardous item 100. Examples of a risk calculation, profiles, and other features, functions and/or embodiments of the present invention will be discussed in more detail below.

By way of further overview and example only, a user profile can be generated based on the historical behavior, schedule, movements, etc. of a user of the potentially hazardous item 100. The system 200 may also consider a context associated with the potentially hazardous item 100 e.g., the type of potentially hazardous item, a location (and/or recent movements) associated with the item 100, how often the potentially hazardous item 100 is used, a current date/time, and other similar information about the potentially hazardous item 100.

In some embodiments, once the processing system 200 calculates the risk value associated with the potentially hazardous item 100, the processing system 200 determines whether that risk value exceeds a risk threshold e.g., by comparing the risk value to the risk threshold. The risk threshold can be predetermined and/or set by the user and can be adjusted by the user and/or adjusted automatically.

The processing system 200 can change the operational state of the potentially hazardous item 100 based at least in part on a determination that the risk value exceeds the risk threshold. For example, if the risk value exceeds the risk threshold, the processing system 200 can deactivate (or defeat one or more operational capabilities of) the potentially hazardous item so that it cannot be used e.g., if the item 100 can be used (by default) unless and until it is deactivated. In another example, the processing system 200 can activate a potentially hazardous item based at least in part on a determination that the risk value is less than the risk threshold, e.g., if the item 100 cannot be used (by default) unless and until it is activated).

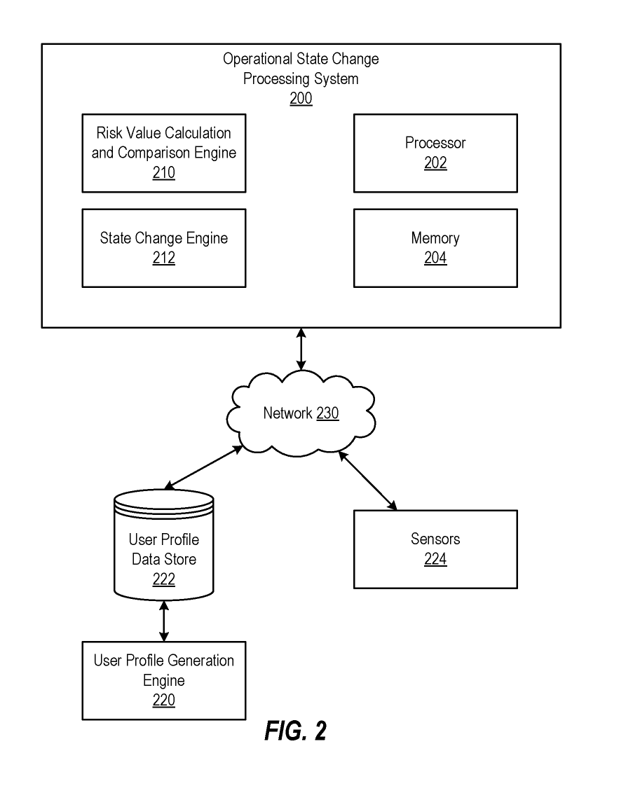

FIG. 2 depicts an example of a system and network according to embodiments of the present invention. As depicted, processing system 200 includes (one or more) processor(s) 202, a memory 204, a risk value calculation and comparison engine 210, and a state change engine 212.

In some embodiments, one or more of the various components, modules, engines, etc. described regarding FIG. 2 can be implemented as: processor executable instructions (aka software) stored in memory 204 (and/or on a computer-readable storage medium (not depicted); as hardware modules; as special-purpose hardware (e.g., application specific hardware, e.g., application specific integrated circuits (ASICs); as embedded controllers; hardwired circuitry, etc.), or as some combination of these. By way of further example, some embodiments, of components, modules, and/or engine(s) can be a combination of hardware and (software) programming. The programming can be processor executable instructions stored on a tangible memory 204, and the hardware can include a processing device such as processor 202 for executing those instructions. Thus, a memory 204 can store program instructions that when executed by the processor 202 implement one or more of the components, modules, and/or engines described herein. In some embodiments, other components, modules, and/or engines (not depicted) can be utilized to perform one or more features and functionality in accordance with the present invention.

Alternatively or additionally, the processing system 200 can include dedicated hardware, such as one or more integrated circuits, application specific integrated circuits (ASICs), application specific special processors (ASSPs), field programmable gate arrays (FPGAs), or any combination of the foregoing, for performing one or more features and functionality in accordance with the present invention.

Referring now specifically to the example depicted in FIG. 2, processing system 200 can be in communication, either directly or indirectly (e.g., via the network 230), with a user profile generation engine 220 that generates a user profile for the potentially hazardous item 100.

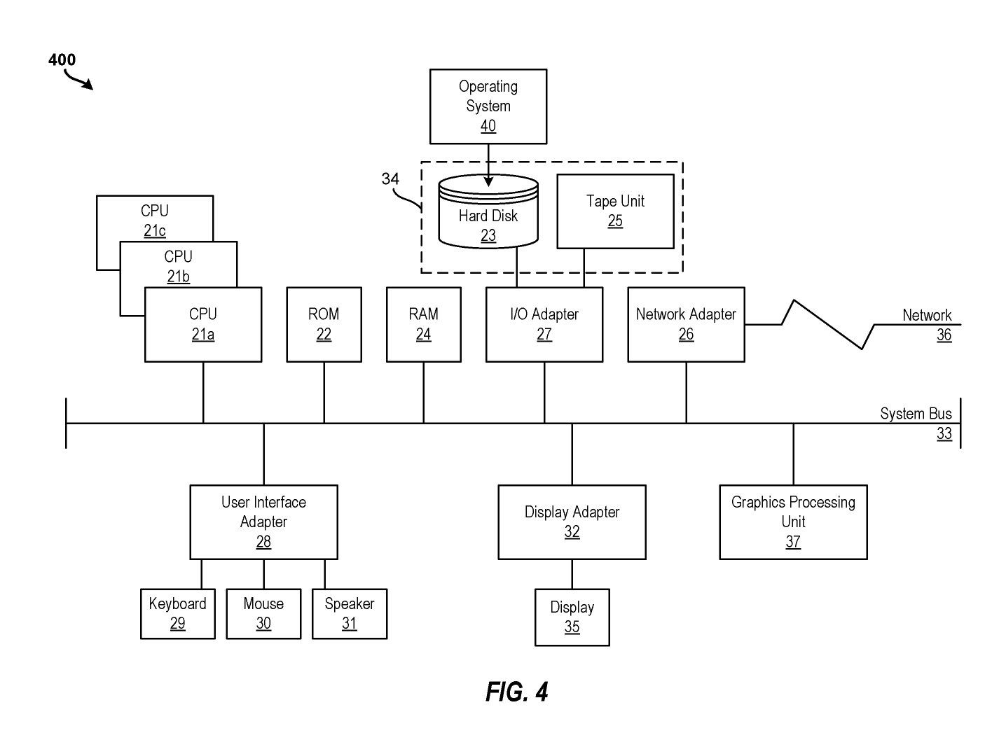

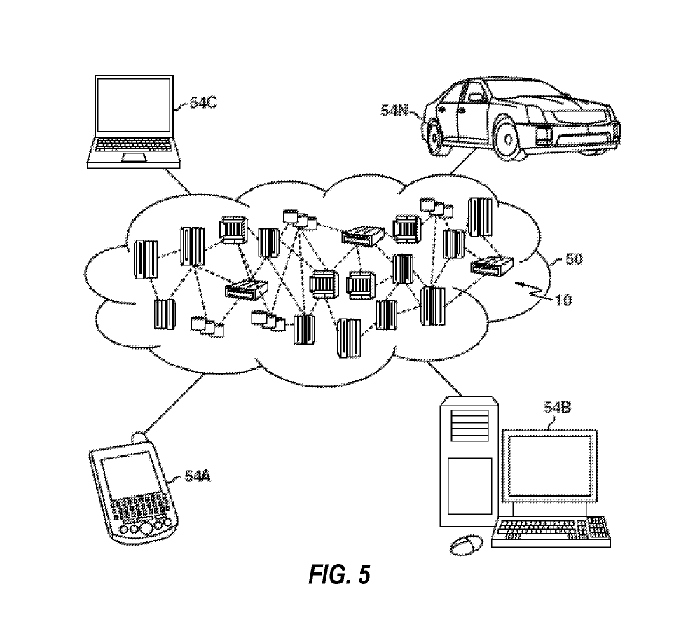

In some embodiments, the user profile generation engine 220 can be more closely coupled to processing system 200, part of a different processing system, such as the will be described with reference to processing system 400 of FIG. 4. In some embodiments, engine 220 is part of a cloud environment, such as will be described with reference to the cloud computing environment 50 of FIG. 5.

Referring again to the example depicted in FIG. 2, the user profile generation engine 220 can generate one or more user profiles 222 for users of a potentially hazardous item, e.g., based on historical user data (not depicted) collected by sensors 224 associated with the item. In some embodiments, the historical user data is collected using one or more sensors 224, which can include a global positioning satellite (GPS) sensor, a gyroscope sensor, an accelerometer sensor, a temperature sensor, and the like. In some embodiments, one or more of sensors 224 can be internal to the item. The use of sensors can facilitate engine 220 to collect data about user behavior and the definition of normal and abnormal usage patterns for the potentially hazardous item 100. The sensors 224 can also include sensors external to the potentially hazardous item (“external sensors”), such as cameras. By way of example only, the use of external sensors can help reduce inappropriate use of the item, e.g., by performing facial recognition on a user and increase the risk value if the user is determined to be an unauthorized user, and/or if the item is determined as causing risk to a child, innocent target, or the like.

In some embodiments, if a user typically carries the potentially hazardous item 100 to a shooting range each Tuesday evening and each Saturday morning, the engine 220 detects these patterns and builds them into the user profile. Accordingly, the user profile can indicate that such movements to and/or location of the potentially hazardous item 100 is “normal” or expected. The user profile generation engine 220 stores the generated profiles in a data store (i.e., a data repository) such as the user profiles data store 222, which is accessible to the processing system 200 either directly or indirectly (e.g., through network 230). Additionally, in some embodiments the user profile generation engine 220 can learn (e.g., based on sensor information) a user's physiological condition, such as breathing, heart rate, and the like, when the user is carrying and/or using the potentially hazardous item 100.

The risk value calculation and comparison engine 210 can include machine learning functionality. The phrase “machine learning” broadly describes a function of electronic systems that learn from data. A machine learning system, engine, or module can include a trainable machine learning algorithm that can be trained, such as in an external cloud environment, to learn functional relationships between inputs and outputs that are currently unknown, and the resulting model transferred to the operational state change processing system 200 to take appropriate action. In one or more embodiments, machine learning functionality can be implemented using an artificial neural network (ANN) having the capability to be trained to perform a currently unknown function. In machine learning and cognitive science, ANNs are a family of statistical learning models inspired by the biological neural networks of animals, and in particular the brain. ANNs can be used to estimate or approximate systems and functions that depend on a large number of inputs.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was read.

Referring again to the example depicted in FIG. 2, the risk value calculation and comparison engine 210 calculates a risk value associated with the potentially hazardous item and determines whether the risk value exceeds a risk threshold. The risk value calculation and comparison engine 210 can receive data from sensors 224 (internal to the potentially hazardous item 100 and/or external to the potentially hazardous item 100) such as cameras, accelerometers, GPS, etc. Based at least in part on the data received from the sensors 224 and the user profile generated by the engine 220, the risk value calculation and comparison engine 212 can calculate a risk value associated with the potentially hazardous item 100. For example, a higher risk value may result if the potentially hazardous item 100 is determined to be in an unusual place in the house (e.g., a child's room), and/or if a child is detected within a certain proximity to the potentially hazardous item (e.g., through image recognition from a camera), or if some other abnormal context is detected.

In some embodiments, the risk value can be one of low, medium, and high, and the risk threshold can be set to one of low, moderate, and high. For example, if the risk threshold is set to moderate, the risk value calculation and comparison engine 212 would determine that the risk value exceeds the threshold if the risk value is determined to be high.

In some embodiments, the risk value can be calculated as a score in a range between 1 and 10 where different factors contribute to the score. For example, the risk value calculation and comparison engine 212 receives data from an accelerometer (e.g., one of the sensors 224) of the potentially hazardous item 100 indicative of a child handling the potentially hazardous item 100, the risk value can be calculated as being 10. If the risk threshold is less than 10, the operational state of the potentially hazardous item can be changed. However, if data from one or more sensors 224 (e.g., an accelerometer) detect an authorized/known user, such as the owner of the potentially hazardous item 100, properly handling the potentially hazardous item 100, then the risk value calculation can be low, such as 1 or 2. The user can be determined to be known based on the user profile stored in the user profile data repository 222 as generated by the user profile generation engine 220.

In some embodiments, the risk value calculation and comparison engine 210 considers the context of the potentially hazardous item 100 by determining an action y performed by user u on the potentially hazardous item p at a time t in a location l as a set {y, u, p, t, l}. Action history Y is also considered (i.e., whether the user u has performed the action before at the same time on the same potentially hazardous item). For example, if the user u took the action y of firing the potentially hazardous item p at the same location l at the same time t, then the risk value can be calculated to be low. If, however, if the user u took the action y of firing the potentially hazardous item p but at a different location l′ at a different time t′, then the risk value can be calculated to be moderate. If a different user u′ is attempting to take the action y of firing the potentially hazardous item p at a different location l′ (e.g., a school) at a different time t′ (e.g., during school hours) than the potentially hazardous item p is typically fired, then the risk value can be calculated to be high.

In some embodiments, the risk value calculation and comparison engine 212 can utilize data from social networks to calculate the risk value. For example, other the user's action at time t can be influenced by other users' actions around time t based on related contexts, locations, etc. For example, if other users are performing the action y at time t in the location l, the risk value can be determined to be low. Other user's behavior from social networks (or other publically available data) can be used to augment the risk value determination. Other users' actions that have a strong correlation with the current user u can indicate a lower risk value.

According to aspects of an embodiment of the present invention, a sample risk/impact function used to calculate the risk value is as follows:

R(θ,δ)=E_{θ}L(θ,δ(X))=∫ₓL(θ,δ(dP_{θ}(X),

where δ is a fixed (possibly unknown) state of nature, X is a vector of observations stochastically drawn from a population (e.g., prior potentially hazardous item usage, list of related actions, user's cognitive state, etc.), θ is the expectation over all the population values of X, dP_{θ} is a probability measure over the event space of X, parameterized by δ, and the integral is evaluated over the entire support of X. For example, if the risk value is greater than the risk threshold, the operational state of the potentially hazardous item 100 is changed.

The state change engine 212 changes the operational state of the potentially hazardous item from the first state to the second state based at least in part on a determination that the risk value exceeds the risk threshold. Changing the operational state can include changing from an activated state to a deactivated state. If it is later determined by the risk value calculation and comparison engine 210 that the risk value no longer exceeds the risk threshold, then the state change engine 212 can change the operational state of the potentially hazardous item back to the activated state from the deactivated state. In another embodiment, the potentially hazardous item 100 can be reactivated after a predetermined period of time (e.g., 1 hour, 3 hours, etc.) or after being manually reactivated by the owner of the potentially hazardous item 100 (e.g., by entering an authorization code).

The state change engine 212 can change the operational state of the potentially hazardous item, such as to a disabled (or inactive) state, in several different ways. For example, the state change engine 212 can cause the items temperature to heat up so that it is too hot to be held, switch to a safe mode by disabling the trigger or firing pin, render the item inactive, sound an alarm, and/or initiate a call to law enforcement, and the like. In some embodiments of the present invention, the processing system 200 can notify an owner of the potentially hazardous item 100, such as by sending a text message, email, or other electronic communication that the operational state of the potentially hazardous item has changed and/or that the risk threshold is exceeded.

In some embodiments, the potentially hazardous item 100 can be associated with a “safe” place, such as a storage location, gun safe, etc. In such cases, the potentially hazardous item 100 can be changed to a deactivated state when the potentially hazardous item 100 is put into its safe place, regardless of the risk value and/or the risk threshold.

In another embodiment, the potentially hazardous item 100 can be associated with an “active” place, such as a shooting range. In these cases, the potentially hazardous item 100 can be changed to an activated state regardless of the risk value and/or the risk threshold. However, in some cases, the risk value can be calculated to determine whether to deactivate the potentially hazardous item 100 even at the “active” place (e.g., if the potentially hazardous item 100 is pointed at a person).

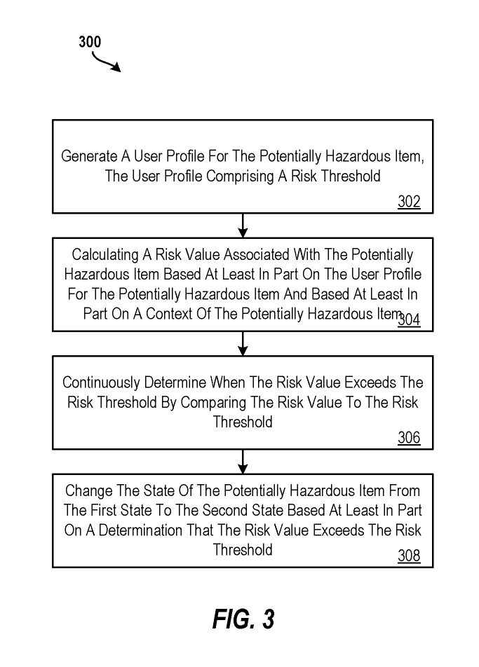

FIG. 3 depicts an example of a computer-implemented method according to embodiments of the present invention. In some embodiments, one or more aspects of method 300 are performed by the operational state change processing system 200 of FIGS. 1 and 2, by the processing system 400 of FIG. 4, by cloud environment such as is depicted in FIG. 5, or by another suitable processing device.

At block 302, the method 300 includes generating, e.g., by engine 220, a user profile for the potentially hazardous item. The user profile can includes a risk threshold which can be set by a user or predefined to a default risk threshold and can be automatically and/or manually adjustable. In some embodiments, generating the user profile for the potentially hazardous item is based at least in part on an action performed by the user on the potentially hazardous item at a time.

At block 304, the method 300 includes calculating, e.g., by the risk value calculation and comparison engine 210, a risk value associated with the potentially hazardous item. The risk value can be calculated based at least in part on the user profile for the potentially hazardous item and based at least in part on a context of the potentially hazardous item.

At block 306, the method 300 includes continuously determining, e.g., by the risk value calculation and comparison engine 210, whether the risk value exceeds the risk threshold by comparing the risk value to the risk threshold.

At block 308, the method 300 includes changing, e.g., by the state change engine 212, the operational state of the potentially hazardous item from the first state to the second state based at least in part on a determination that the risk value exceeds the risk threshold. For example, the state change engine 212 can change the operational state of the potentially hazardous item to a deactivated state when the risk value exceeds the risk threshold.

Additional processes also can be included. For example, the method 300 can further include changing, e.g., by the state change engine 212, the operational state of the potentially hazardous item from a current state to another state, based at least in part on a determination that the risk value does not exceed the risk threshold. In some embodiments, the method 300 can further include generating, e.g., by the user profile generation engine 220, a second user profile for the potentially hazardous item, the second user profile including a second risk threshold different from the first risk threshold of the first user profile. This can enable the potentially hazardous item to be associated with different users e.g., who have different patterns, schedules, behaviors, etc.

It should be understood that the processes depicted in FIG. 3 represent illustrations, and that other processes can be added or existing processes can be removed, modified, or rearranged without departing from the scope and spirit of the present invention.

It is understood in advance that the present invention is capable of being implemented in conjunction with any other type of computing environment now known or later developed. For example, FIG. 4 depicts another example of a system according to embodiments of the present invention. In embodiments of the present invention, processing system 20 has one or more central processing units (processors) 21a, 21b, 21c, etc. (collectively or generically referred to as processor(s) 21 and/or as processing device(s)). In aspects of the present invention, each processor 21 can include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and can include a basic input/output system (BIOS), which controls certain basic functions of processing system 20.

Further illustrated are an input/output (I/O) adapter 27 and a communications adapter 26 coupled to system bus 33. I/O adapter 27 can be a small computer system interface (SCSI) adapter that communicates with a hard disk 23 and/or a tape storage drive 25 or any other similar component. I/O adapter 27, hard disk 23, and tape storage device 25 are collectively referred to herein as mass storage 34. Operating system 40 for execution on processing system 20 can be stored in mass storage 34. A network adapter 26 interconnects system bus 33 with an outside network 36 enabling processing system 20 to communicate with other such systems.

A display (e.g., a display monitor) 35 is connected to system bus 33 by display adaptor 32, which can include a graphics adapter to improve the performance of graphics intensive applications and a video controller. In one aspect of the present invention, adapters 26, 27, and/or 32 can be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 can be interconnected to system bus 33 via user interface adapter 28, which can include, for example, a Super I/O chip integrating multiple device adapters into a single integrated circuit.

In some aspects of the present invention, processing system 20 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing, and has a highly parallel structure that makes it more effective than general-purpose CPUs for algorithms where processing of large blocks of data is done in parallel.

Thus, as configured herein, processing system 20 includes processing capability in the form of processors 21, storage capability including system memory (e.g., RAM 24), and mass storage 34, input means such as keyboard 29 and mouse 30, and output capability including speaker 31 and display 35. In some aspects of the present invention, a portion of system memory (e.g., RAM 24) and mass storage 34 collectively store an operating system such as the AIX® operating system from IBM Corporation to coordinate the functions of the various components shown in processing system 20.

In some embodiments, one or more aspects of the present invention can be implemented in a cloud computing environment. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure including a network of interconnected nodes.

FIG. 5 depicts an example of a cloud computing environment according to embodiments of the present invention. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

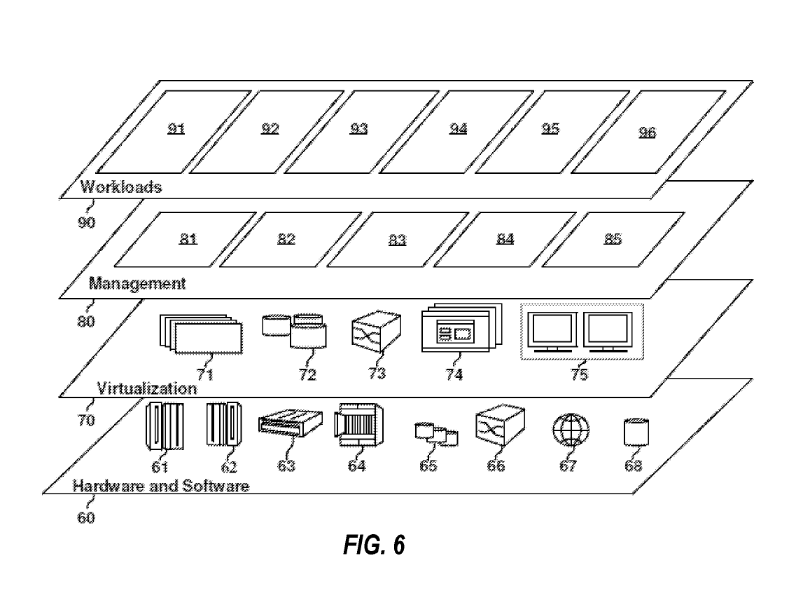

FIG. 6 depicts an example of abstraction model layers of a system according to embodiments of the present invention. It should be understood in advance that the components, layers, and functions shown in FIG. 6 are intended to be illustrative only and embodiments of the invention are not limited thereto. As illustrated, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one embodiment, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one embodiment, these resources can include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and operational state processing for a potentially hazardous item in accordance with the present invention 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques described herein.

What is claimed:

1-9. (canceled)

10. A system for changing a state of a potentially hazardous item, comprising:
a memory comprising computer readable instructions; and
a processing device for executing the computer readable instructions for performing a method, the method comprising:
generating, by the processing device, a profile for the potentially hazardous item;
calculating, by the processing device, a risk value associated with the potentially hazardous item, based at least in part on the profile; and
changing, by the processing device, the state of the potentially hazardous item based at least in part on a calculated risk value.

11. The system of claim 10, wherein the method further comprises:
determining that the risk value does not exceed a risk threshold; and
changing an operational state of the potentially hazardous item, in response to said determining that the risk value does not exceed a risk threshold.

12. The system of claim 10, said changing, by the processing device, the state of the potentially hazardous item based at least in part on a calculated risk value, further comprises changing, by the processing device, the state of the potentially hazardous item from an active state to an inactivate state.

13. The system of claim 10, wherein the potentially hazardous item is selected from the group consisting of a handgun, a rifle, a shotgun, an aerosol spray, and an electroshock generating item.

14. The system of claim 10, wherein generating the user profile for the potentially hazardous item is based at least in part on an action performed by the user on the potentially hazardous item at a time.

15. The system of claim 10, wherein the risk value is calculated based at least in part on
R(θ,δ)=E_{θ}L(θ,δ(X))=∫ₓL(θ,δ(dP_{θ}(X),
where δ is a fixed state of nature, X is a vector of observations stochastically drawn from a population, θ is an expectation over population values of X, dP_{θ} is a probability measure over X parameterized by δ, and the integral is evaluated over X.

16. The system of claim 10, wherein said calculating, by the processing device, a risk value associated with the potentially hazardous item, based at least in part on the profile further comprises: determining a context of the potentially hazardous item, based at least in part on a sensor associated with the potentially hazardous item.

17. The system of claim 16, wherein the sensor is selected from a group consisting of: a global positioning satellite (GPS) sensor, a gyroscope sensor, an accelerometer sensor, and a temperature sensor.

18. The system of claim 1, wherein the profile includes a plurality of user profiles and a plurality of risk values, further comprising: generating, by the processing device, a second user profile for the potentially hazardous item, the second user profile comprising a second risk value different from a first risk value associated with a first user profile.

19. A computer program product for changing a state of a potentially hazardous item, comprising:
a computer readable storage medium having program instructions embodied therewith, wherein the computer readable storage medium is not a transitory signal per se, the program instructions executable by a processing device to cause the processing device to perform a method comprising:
generating, by the processing device, a profile for the potentially hazardous item;
calculating, by the processing device, a risk value associated with the potentially hazardous item, based at least in part on the profile; and
changing, by the processing device, the state of the potentially hazardous item based at least in part on a calculated risk value.

20. The computer program product of claim 19, wherein the method further comprises:
determining that the risk value does not exceed a risk threshold; and
changing an operational state of the potentially hazardous item, in response to said determining that the risk value does not exceed a risk threshold.
